(19) United States
(12) Patent Application Publication
(10) Pub. No.: US 2014/0207490 A1
(43) Pub. Date: Jul. 24, 2014

(54) AUTHENTICATION SYSTEM IN FACILITY

(71) Applicant: Panasonic Corporation, Osaka (JP)

(72) Inventors: Tomoyuki SHINDO, Kyoto (JP); Yoshihiko MATSUKAWA, Nara (JP); Makoto GOTOU, Hyogo (JP); Takanobu TANIMOTO, Ehime (JP); Masaaki IKEHARA, Osaka (JP)

(73) Assignee: Panasonic Corporation, Osaka (JP)

(21) Appl. No.: 14/157,206

(22) Filed: Jan. 16, 2014

(30) Foreign Application Priority Data
Jan. 18, 2013 (JP) 2013-006803
Nov. 6, 2013 (JP) 2013-229871

(51) Int. Cl. G06F 19/00

(52) U.S. Cl. CPC G06F 19/322
USPC 705/3

(57) ABSTRACT

A first luminaire 22 emits visible light 22a including, as information, an illumination ID for specifying a location in a facility. Photoreceivers 23 to 26, which prestore target IDs, transmit the illumination ID based on the visible light 22a and the prestored target IDs as data when receiving the visible light 22a. A processing unit 30 associates the photoreceivers 23 to 26 located in the illumination area of the same first luminaire 22 based on the data transmitted from the photoreceivers 23 to 26. Treatment is authenticated by deciding whether or not a combination of the associated photoreceivers 23 to 26 matches a combination of the photoreceivers based on a treatment order.

### FIELD OF THE INVENTION

The present invention relates to an authentication system in a facility, the system performing authentication when a subject is treated in the facility, e.g., a hospital.

### BACKGROUND OF THE INVENTION

For example, treatment on a patient in a hospital involves a plurality of medical staff members (e.g., nurses, pharmacists, and doctors). However, a specific nurse and a specific doctor are in charge of a patient. Furthermore, a specific nurse or a specific doctor is selected in each step of specific treatment. In this case, precise recording of medical information on patients is considered to contribute to medical service improvement with higher precision and safety.

As a system for precisely recording medical information on patients, Japanese Patent Laid-Open No. 2000-175872 discloses a biological information management system for recording biological information (including a uric acid level) on a specific patient.

A management system 1 in the block diagram of FIG. 9 can transmit and receive biological information and diagnostic results between a user home 2, a medical institution 3, and an information service center 11. The user home 2 is the home of a user who intends to collect biological information.

As shown in FIG. 9, the management system 1 includes a urine testing device 6 installed in a toilet 4 of the user home 2, a blood flow testing device 7, and a weighing machine 8. The urine testing device 6 is a device for testing a uric acid level and is attached to a toilet bowl 5. The blood flow testing device 7 is a device for testing a finger blood pressure. The weighing machine 8 is a machine for measuring a weight. These devices allow the management system 1 to collect user biological information such as a uric acid level, a blood pressure, and a weight. The collected biological information is transmitted to a child node 9a of a communication system and then to a parent node 9b of the communication system. After that, the information is transmitted to a center system 11a of the information service center 11 and a hospital system 3a of the medical institution 3 through a public telecommunication network 10. Thus, the biological information can be recorded in association with the user.

As has been discussed, the management system 1 in FIG. 9 can obtain daily biological information on a user, and record the obtained biological information in association with the user.

However, the conventional management system requires the device fixed at a specific location and thus can collect biological information only at the specific location. Thus, the conventional management system is difficult to operate in a facility where used devices are suitably changed. Moreover, in the conventional management system, a user and biological information are associated with each other by a user operation. Thus, the biological information and the user may be incorrectly associated with each other. In other words, in the conventional management system, recorded biological information is limited to measurement results obtained by a specific device at a specific location and collected biological information may be incorrectly associated with a user.

### DISCLOSURE OF THE INVENTION

An authentication system in a facility according to the present invention is an authentication system that authenticates treatment based on a treatment order in a facility, the system comprising: a light source that emits illumination light containing an illumination ID for specifying a location in the facility as information; a plurality of photoreceivers that transmit the illumination ID based on the illumination light and a prestored target ID when receiving the illumination light from the light source as data; and a processing unit that associates the photoreceivers located in the illumination area of the same light source based on the data transmitted from the photoreceivers, and authenticates treatment by deciding whether or not a combination of the associated photoreceivers matches a combination of the photoreceivers based on the treatment order.

### BRIEF DESCRIPTION OF THE DRAWINGS

FIG. 1A is a side view of a hospital room schematically showing the configuration of an authentication system according to an embodiment of the present invention;

FIG. 1B is a plan view of the hospital room schematically showing the configuration of the authentication system according to the embodiment of the present invention;

FIG. 2A is a perspective view illustrating an example of the outside shape and the configuration of a photoreceiver according to the embodiment of the present invention;

FIG. 2B is a perspective view illustrating an example of the outside shape and the configuration of a photoreceiver according to the embodiment of the present invention;

FIG. 2C is a perspective view illustrating an example of the outside shape and the configuration of a photoreceiver according to the embodiment of the present invention;

FIG. 2D is a perspective view illustrating an example of the outside shape and the configuration of a photoreceiver according to the embodiment of the present invention;

FIG. 3 shows an example of a list in which the photoreceivers and illumination IDs received by the photoreceivers are associated with each other according to the embodiment of the present invention;

FIG. 4 is an explanatory drawing showing an example of a comparison between the associated photoreceivers and treatment orders according to the embodiment of the present invention;

FIG. 5 is a flowchart showing an example of processing performed by the authentication system according to the embodiment of the present invention;

FIG. 6 is a block diagram showing an example of information transmission by the authentication system according to the embodiment of the present invention;

FIG. 7 is a front view showing an example of a cart according to the embodiment of the present invention;

FIG. 8 is a plan view showing the example of the cart according to the embodiment of the present invention;

FIG. 9 is a block diagram showing the overall configuration of a conventional biological information management system; and

FIG. 10 is an explanatory drawing showing the positional relationship between a light source and an auxiliary light source according to the embodiment of the present invention.

### DESCRIPTION OF THE EMBODIMENT

An embodiment of the present invention will be described below with reference to the accompanying drawings. The same constituent elements are indicated by the same reference numerals and the explanation thereof may be omitted. The drawings mainly illustrate the constituent elements in a schematic fashion to enhance understanding.

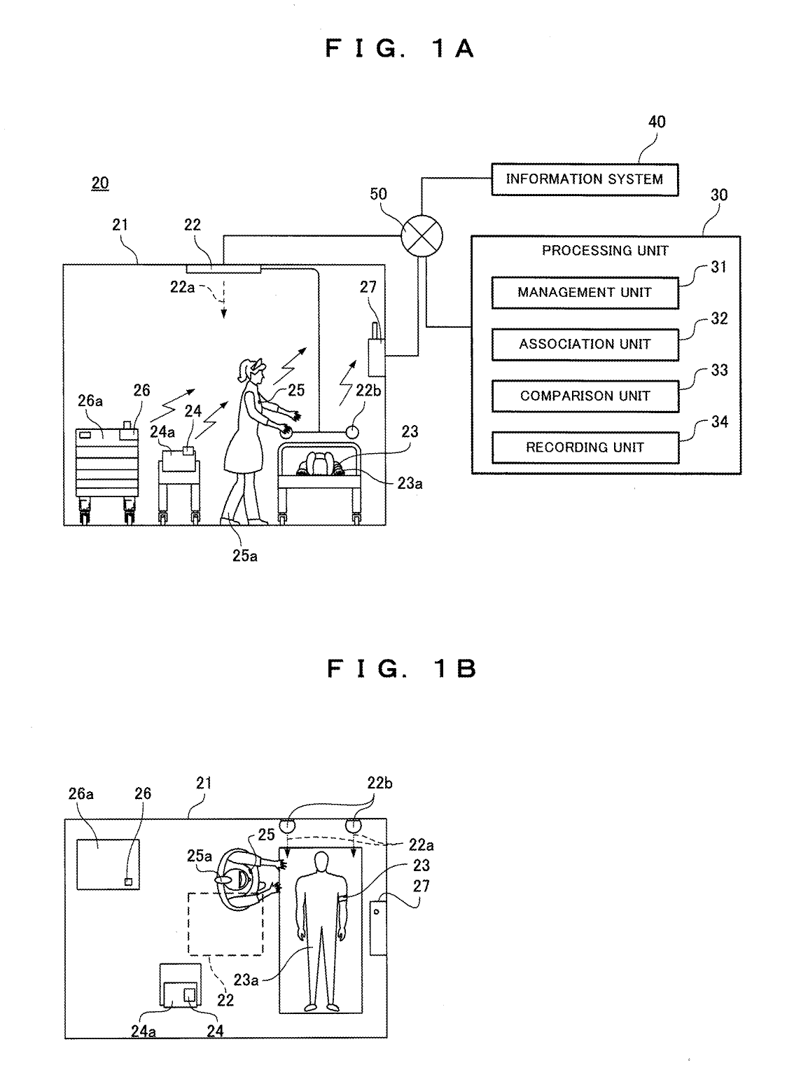

FIGS. 1A and 1B are structural diagrams showing the schematic configuration of an authentication system 20 according to the embodiment of the present invention. FIG. 1A is a side view of a hospital room 21. FIG. 1B is a plan view of the hospital room 21. The authentication system 20 is a system used in facilities such as a hospital and a nursing home. The authentication system 20 is an example of an authentication system in a facility. The authentication system 20 authenticates treatment performed for a treatment order in the facility. The embodiment illustrates the authentication system 20 used in a hospital.

FIGS. 1A and 1B show that a nurse 25a treats a patient 23a on a bed in the hospital room 21 of the hospital. The patient 23a is an example of a subject to be treated. The nurse 25a is an example of a person in charge of treatment on a subject.

For example, in treatment such as administration of a drug to the patient 23a on the bed, a nurse (a person in charge of treatment), a patient (a subject), and a drug are conventionally authenticated using a bar code or an RFID. In the conventional authentication, however, a nurse, a patient, and a drug need to be separately authenticated and thus cannot be authenticated at the same time. Hence, in the conventional authentication, a person other than an authenticated person may perform authenticated treatment on an authenticated patient.

However, in order to provide more precise medical service, continuous authentication is necessary as well as simultaneous authentication. In simultaneous authentication according to the present embodiment, a person in charge of treatment, a subject, and a testing instrument are authenticated at the same time. In continuous authentication according to the present embodiment, the continuous presence of a person in charge of treatment, a subject, a drug necessary for treatment, and a testing instrument is authenticated in a first area during continuous treatment. In this case, the first area is a unique space for treatment in a facility and is an example of a specific space. The first area is, for example, a space for a room such as a hospital room or a bed space surrounded by curtains. In the present embodiment, an example of a facility is a hospital. Also in other facilities, for example, a room space in the facility can be defined as a first area.

The authentication system 20 according to the present embodiment includes a plurality of first luminaires 22 that emit illumination light with superimposed illumination IDs and a plurality of photoreceivers 23 to 26. Moreover, the authentication system 20 according to the present embodiment is a system for real-time management of the superimposed illumination IDs of illumination light received by the photoreceivers 23 to 26. In the following explanation, visible light will be discussed as an example of illumination light. The first luminaires 22 are disposed in respective first areas so as to emit visible light 22a with the superimposed illumination IDs for the respective positions of the first areas. The photoreceivers 23 to 26 are respectively attached to a person in charge of treatment, a subject, and a device necessary for treatment. In the present embodiment, the use of the attached photoreceivers 23 to 26 allows authentication of the continuous presence of a person in charge of treatment, a subject, and a drug and a testing instrument for treatment in the first areas. Thus, according to the authentication system 20 of the present embodiment, the presence of all requirements for treatment on multiple patients (subjects) in a facility, e.g., a hospital can be authenticated. In other words, the authentication system 20 according to the present embodiment precisely confirms the presence of requirements for treatment, authenticating if the treatment can be suitably performed or not.

As shown in FIGS. 1A and 1B, the authentication system 20 according to the present embodiment includes the first luminaires 22, the first photoreceiver 23, the second photoreceiver 24, the third photoreceiver 25, the fourth photoreceiver 26, a communication device 27, a processing unit 30, an information system 40, and a communication network 50. The first photoreceiver 23 is an example of a patient photoreceiver. The second photoreceiver 24 is an example of a measuring device photoreceiver. The third photoreceiver 25 is an example of a nurse photoreceiver and an example of a photoreceiver for a person in charge of treatment. The fourth photoreceiver 26 is an example of a cart photoreceiver. The information system 40 stores information in a facility, e.g., a hospital. The information in a facility such as a hospital is, for example, medical information. The information system 40 is an example of a medical information system. The medical information in a hospital includes the treatment orders of a patient (subject), biological information such as a blood pressure, anamnesis, and the history of drug administration. The treatment orders are information on treatment indicated by a doctor and performed on a patient (subject). The treatment orders will be specifically described later. The biological information is information including a blood pressure or a body temperature of a patient (subject). The anamnesis is information on the history of outpatient treatment of a patient (subject). The history of drug administration is history information on drugs having been administered to a patient (subject). The communication network 50 transmits and receives information between the photoreceivers 23 to 26, the processing unit 30, and the information system 40.

The first luminaire 22 is mounted on the ceiling of the facility. The first luminaire 22 is assigned with an illumination ID corresponding to the position of a specific space (first area). For example, the first luminaire 22 mounted in a private room of a hospital is assigned with an illumination ID corresponding to the position of the private room, whereas the first luminaires 22 mounted in a large room for several patients in the hospital are assigned with illumination IDs for the respective bed positions in the illumination areas of the first luminaires 22. The first luminaires 22 emit the visible light 22a including, as information, the illumination IDs for specifying locations (the first areas) in the facility. In other words, the illumination ID is information for identifying the first area in the facility.

The first luminaire 22 is desirably a light source of LED illumination. The visible light 22a from the first luminaire 22 for LED illumination is, for example, an optical pulse train having a frequency of several MHz and a duty ratio of 50%. In the case of the first luminaire 22 for LED illumination, the first luminaire 22 desirably includes a digital circuit (an example of an illuminance modulation circuit) that modulates an optical pulse train in order to emit the visible light 22a that includes the illumination ID as information. The first luminaire 22 modulates the optical pulse train by means of the digital circuit so as to modulate the illuminance of the emitted visible light 22a. This can superimpose the illumination ID on the visible light 22a.

The first photoreceiver 23 attached to the patient 23a stores, as internal information, a specific photoreceiver ID assigned to the first photoreceiver 23 and a specific patient ID assigned to the patient 23a having the photoreceiver 23. The patient ID is an example of a first target ID. When receiving the visible light 22a, the first photoreceiver 23 transmits the stored photoreceiver ID and first target ID and the illumination ID based on the received visible light 22a to the processing unit 30 through the communication device 27 and the communication network 50.

If the first luminaire 22 is an LED lamp and the illuminance of the visible light 22a is modulated to superimpose the illumination ID, the photoreceivers 23 to 26 each desirably include a digital circuit (an example of a decoding circuit) for decoding the illumination ID based on the received visible light 22a.

The second photoreceiver 24 attached to a measuring device 24a for measuring biological information on the patient 23a stores, as internal information, a specific photoreceiver ID assigned to the second photoreceiver 24 and a specific measuring device ID assigned to the measuring device 24a having the second photoreceiver 24. The measuring device ID is an example of a second target ID. The measuring device 24a is an example of a device for treating a patient. When receiving the visible light 22a, the second photoreceiver 24 transmits the stored photoreceiver ID and second target ID and the illumination ID based on the received visible light 22a to the processing unit 30 through the communication device 27 and the communication network 50.

The third photoreceiver 25 attached to the nurse 25a in charge of the patient 23a stores, as internal information, a specific photoreceiver ID assigned to the third photoreceiver 25 and a specific nurse ID assigned to the nurse 25a having the third photoreceiver 25. The nurse ID is an example of a third target ID. When receiving the visible light 22a, the third photoreceiver 25 transmits the stored photoreceiver ID and third target ID and the illumination ID based on the received visible light 22a to the processing unit 30 through the communication device 27 and the communication network 50.

The fourth photoreceiver 26 is attached to a cart 26a for carrying a drug and a device that are necessary for treatment on the patient 23a, and stores, as internal information, a specific photoreceiver ID assigned to the fourth photoreceiver 26 and a specific cart ID assigned to the cart 26a having the fourth photoreceiver 26. The cart ID is an example of a fourth target ID. The cart 26a is an example of a device for treating a patient. When receiving the visible light 22a, the fourth photoreceiver 26 transmits the stored photoreceiver ID and fourth target ID and the illumination ID based on the received visible light 22a to the processing unit 30 through the communication device 27 and the communication network 50.

The information system 40 is a system for controlling information such as electronic medical charts and treatment orders, and includes a recording medium for recording information such as electronic medical charts and treatment orders. The information on treatment orders includes information on a doctor who has indicated predetermined treatment, information on the contents of the predetermined treatment, and information on time periods for the predetermined treatment. Furthermore, the information on treatment orders includes the photoreceiver ID and the first target ID that specify the patient 23a to be subjected to the predetermined treatment, and information such as the photoreceiver ID and the third target ID that specify a person in charge of the predetermined treatment on the patient 23a. If the predetermined treatment requires the measuring device 24a, the treatment orders include information on the photoreceiver ID and the second target ID that specify the measuring device 24a. If the cart 26a is necessary for carrying a drug for the predetermined treatment, the treatment orders include information on the photoreceiver ID and the fourth target ID that specify the cart 26a. In this way, for each kind of predetermined treatment on a patient, the recording medium of the information system 40 stores, as a requirement for the predetermined treatment, a combination of the photoreceiver ID of the photoreceiver and the target ID (the first to fourth target IDs) which need to be present in the same location during a treatment time period. The information system 40 allows the use of an existing system in a hospital.

The processing unit 30 carries out communications with the photoreceivers 23 to 26 and the information system 40 through the communication network 50. Moreover, the processing unit 30 includes a management unit 31, an association unit 32, a comparison unit 33, and a recording unit 34 in order to manage information such as photoreceivers ID transmitted from the photoreceivers 23 to 26.

The management unit 31 identifies the superimposed illumination IDs of the visible light 22a received by the photoreceivers 23 to 26, in real time for the respective photoreceivers 23 to 26 based on the illumination IDs, the photoreceiver IDs, and the target IDs that are transmitted from the photoreceivers 23 to 26. The management unit 31 can identify in real time combinations of the photoreceiver IDs and the target IDs, which are stored in the photoreceivers 23 to 26, and illumination IDs currently received by the photoreceivers 23 to 26. The use of the illumination IDs makes it possible to confirm in real time whether or not the photoreceivers 23 to 26 are present in the illumination area of the first luminaire 22 and manage the photoreceivers 23 to 26. In other words, the first areas containing the photoreceivers 23 to 26 can be identified and managed in real time by using the illumination IDs.

The association unit 32 associates the photoreceivers located in the illumination area of the same first luminaire 22, based on information managed by the management unit 31. The association unit 32 can associate the photoreceivers that receive the visible light 22a at the same time, the visible light 22a including the same illumination ID as information.

The comparison unit 33 compares, in a predetermined treatment time period, combinations of the photoreceiver IDs and the target IDs that are stored in the photoreceivers associated by the association unit 32 and combinations of the photoreceiver IDs and the target IDs that are included in information on treatment orders received from the information system 40 through the communication network 50, and then the comparison unit 33 decides if there is a match.

If a match between the combinations of the photoreceiver IDs and the target IDs is continuously confirmed based on a decision by the comparison unit 33, the recording unit 34 records information that specifies a treatment time, a treatment location, a person in charge of treatment, and a subject, based on the combinations of the photoreceiver IDs and the target IDs, the illumination IDs, and a current time. The continuous confirmation of a combination match by the comparison unit 33 specifically means a continuous decision that there is a match between combinations of the photoreceiver IDs and the target IDs transmitted from the photoreceivers located in the illumination area of the same first luminaire 22 and combinations of the photoreceiver IDs and the target IDs that are included in treatment orders transmitted from the information system 40. In this case, the treatment time is a time when predetermined treatment is performed, the treatment location is a location where the treatment is performed, and the subject is, for example, a treated patient. The recording unit 34 may record the contents of treatment in information on treatment orders or measurement results that are obtained by the measuring device and transmitted from the measuring device (or the photoreceiver attached to the measuring device) used in treatment on a patient. The recording unit 34 may be provided in the information system 40. Since the recording unit 34 automatically records information, treatment can be clarified with higher accessibility. Data on performed treatment can be used to improve future medical treatment and increase efficiency.

As will be discussed later, the processing unit 30 may have the function of informing a person in charge of treatment, e.g., the nurse 25a of permission for treatment when a match result is confirmed in combinations of the photoreceiver IDs and the target IDs based on a decision by the comparison unit 33.

This function allows the processing unit 30 of the present embodiment to confirm the illumination IDs received by the photoreceivers 23 to 26, authenticate the continuous presence of a subject and a person in charge of treatment in the same location in a time period (a predetermined treatment time period) during which treatment on the subject is started, and inform the person in charge of treatment of permission for the treatment.

In this way, the authentication system 20 of the present embodiment achieves simultaneous and continuous authentication for treatment on a subject (e.g., the specific patient 23a). Specifically, the authentication system 20 of the present embodiment can always manage the illumination IDs received by the photoreceivers 23 to 26 so as to simultaneously and continuously confirm and authenticate the presence of a subject, a person in charge of treatment, and a device used for treatment in the same location. Thus, predetermined treatment can be precisely authenticated. In simultaneous and continuous authentication, treatment can be permitted and a treatment time, a treatment location, a person in charge of treatment, and a subject can be recorded. Moreover, the authentication system 20 of the present embodiment uses the first luminaires 22 that emit the visible light 22a with the superimposed illumination IDs during authentication. Thus, devices do not need to be in contact with each other, achieving clean authentication and recording.

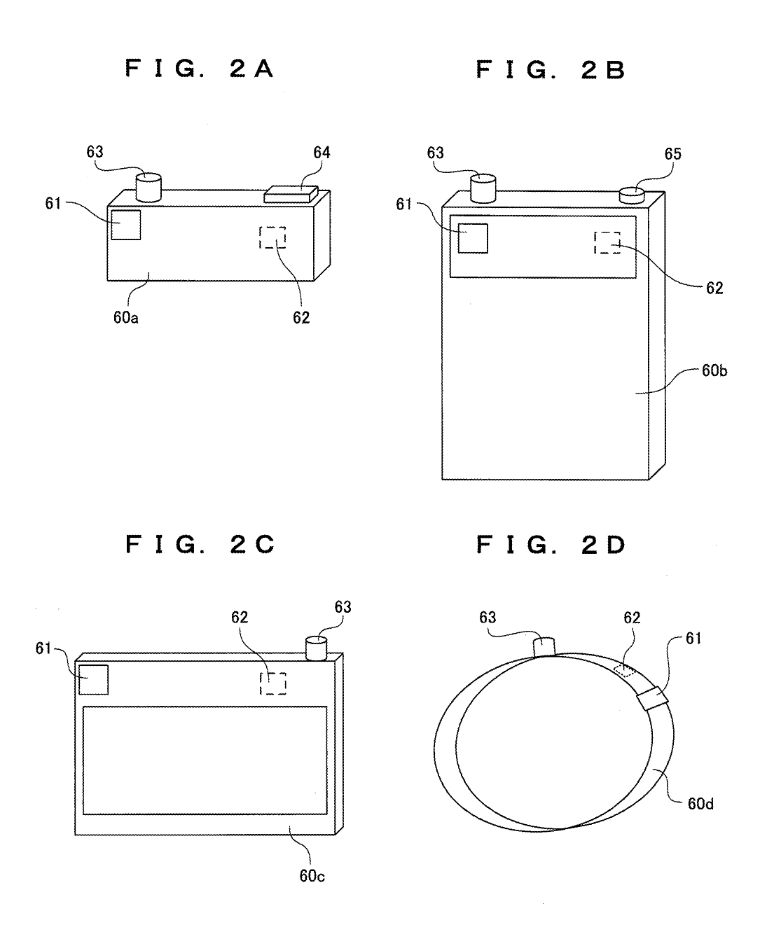

FIGS. 2A to 2D are perspective views illustrating examples of the outside shape and configuration of the photoreceiver used in the authentication system 20.

A device-mounted photoreceiver 60a in FIG. 2A is an example of the second photoreceiver 24. The photoreceiver 60a includes at least a light receiving part 61 that receives the visible light 22a and a communication part 62 containing a wireless LAN or a radio frequency identification (RFID) for exchanging information through wireless communications. The photoreceiver 60a may optionally include a light emitting part 63. The light emitting part 63 desirably lights up or blinks if the illumination ID based on the visible light 22a received by the light receiving part 61 matches a treatment order. The light emitting part 63 lighting up or blinking easily provides a real-time visual notification to a person in charge of treatment, e.g., the nurse 25a of the authentication of a device having the photoreceiver 60a. When a signal indicating permission for treatment is received from the processing unit 30, the light emitting part 63 lighting up or blinking can easily notify a person in charge of treatment, e.g., the nurse 25a of the permission for treatment. Furthermore, the photoreceiver 60a may optionally include a sound generator, e.g., a beeper that notifies a person in charge of treatment, e.g., the nurse 25a of permission for treatment with a beep when receiving a signal indicating the permission for treatment from the processing unit 30. Moreover, the photoreceiver 60a may optionally include, for example, a USB port 64 that enables communications with the processing unit 30 through wiring. Alternatively, a person in charge of treatment, e.g., the nurse 25a may be notified of the completion of authentication for a treatment order by e-mail. An e-mail may be sent to a cellular phone for medical care of the nurse 25a or the photoreceiver 60a may have an e-mail function of sending an e-mail to the third photoreceiver 25. Alternatively, the photoreceiver 64a may have the vibrating function of notifying the nurse 25a of the completion of authentication by vibrations.

A box-shaped photoreceiver 60b in FIG. 2B is an example of the fourth photoreceiver 26. Like the photoreceiver 60a in FIG. 2A, the photoreceiver 60b includes at least the light receiving part 61 and the communication part 62. The photoreceiver 60b optionally includes the light emitting part 63. Like the photoreceiver 60a in FIG. 2A, the photoreceiver 60b may optionally include a sound generator. Alternatively, the photoreceiver 60b may optionally include a plug terminal 65 that enables communications with the processing unit 30 through wiring.

A nameplate photoreceiver 60c in FIG. 2C and a bracelet photoreceiver 60d in FIG. 2D are examples of the first photoreceiver 23 and the third photoreceiver 25. Like the photoreceiver 60a in FIG. 2A, each of the photoreceiver 60c and the photoreceiver 60d includes at least the light receiving part 61 and the communication part 62 and optionally includes the light emitting part 63. The photoreceivers 60c and 60d are attached to the chest or arm of the patient 23a or the nurse 25a.

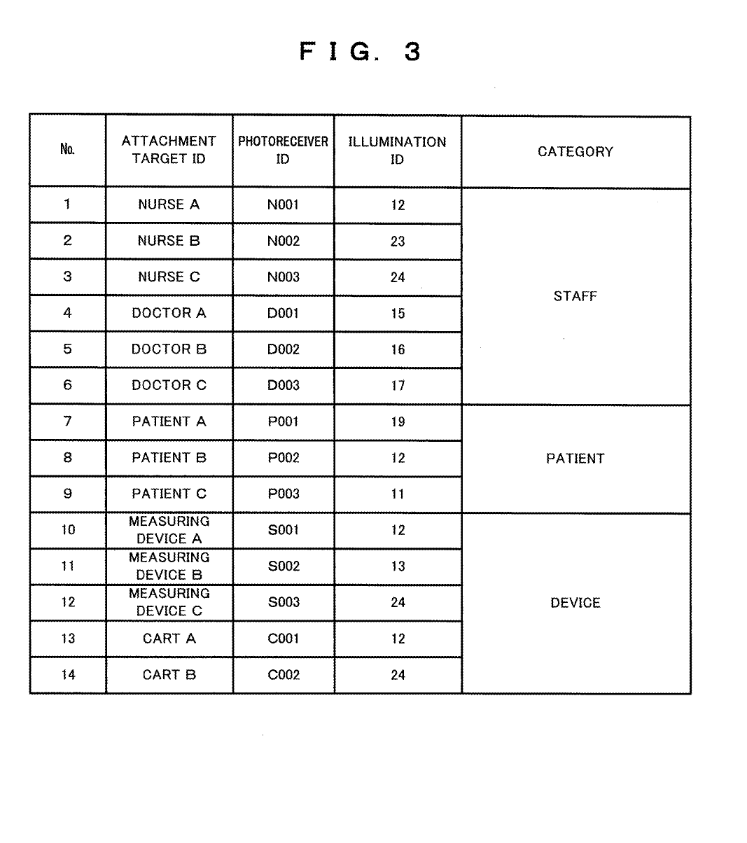

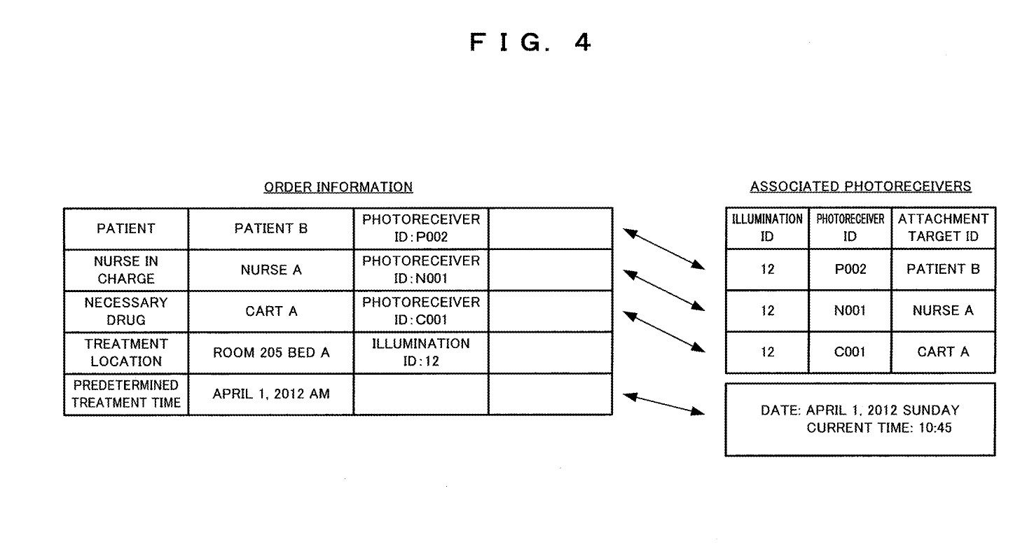

The management unit 31 of the processing unit 30 manages the illumination IDs by creating, for example, a list in which the photoreceivers 23 to 26 and the illumination IDs received by the photoreceivers 23 to 26 are associated with each other. FIG. 3 shows an example of the list. In the example of FIG. 3, the management unit 31 manages, for the respective photodetectors, target IDs having the photoreceivers, photoreceiver IDs specific to the photoreceivers, illumination IDs, and category information. The category information is information for categorizing the target IDs into facility staff members including a nurse and a doctor, subjects such as a patient, and devices including a measuring device and a cart. The management unit 31 may further contain, for example, position information in a facility based on the illumination IDs, in addition to the information in FIG. 3. The management unit 31 may further contain information on the performance and usage periods of devices having the photoreceivers 24 and 26 and information on the positions, skills, and certifications of persons in charge of treatment in a facility, e.g., a nurse and a doctor having the third photoreceivers 25. This information is desirably set as usable information when the access right of a viewer exceeds an information security level.

The association unit 32 of the processing unit 30 associates the photoreceivers having received the same illumination ID, from the list shown in FIG. 3. For example, in the list of FIG. 3, the photoreceivers with an illumination ID of “12” are associated with a No. 1 photoreceiver ID of “N001”, a No. 8 photoreceiver ID of “P002”, a No. 10 photoreceiver ID of “S001”, and a No. 13 photoreceiver ID of “C001”. The photoreceivers associated in this way are authenticated as photoreceivers located at the same place at the same time.

The comparison unit 33 of the processing unit 30 compares combinations of the photoreceiver IDs and the target IDs, which are stored in the photoreceivers authenticated as photoreceivers located in the illumination area of the same first luminaire 22 by the association unit 32 and combinations of the photoreceiver IDs and the target IDs that are contained in the information on treatment orders stored in the information system 40. The operations of the comparison unit 33 will be described below with reference to the list of FIG. 3 and information on treatment orders (order information) in FIG. 4. The information on treatment orders is an example of order information. The order information in FIG. 4 includes information about a nurse A having the photoreceiver with a photoreceiver ID “N001”. The nurse A treats a patient B having the photoreceiver with a photoreceiver ID “P002” at a predetermined treatment time “in the morning of Apr. 1, 2012” by using a drug stored in a cart A having the photoreceiver with a photoreceiver ID “C001” in a treatment location (Room No. 205, a bed A) where a light source with an illumination ID “12” is mounted. In this case, the order information and information on the associated photoreceivers are compared with each other. As shown in FIG. 4, for the combination with the illumination ID “12”, it is confirmed whether or not the photoreceiver ID, the target ID, and the current time match the order information. If a perfect match is found and continued, a person in charge of treatment, a subject, and a drug necessary for treatment are authenticated as being continuously present in the same location at the same time. Additionally, the used measuring device 24a may be authenticated as well, which is not shown in FIG. 4.

Automatic recording of kinds of information by the recording unit 34 of the processing unit 30 clarifies treatment with higher accessibility. Data on performed treatment can be used to improve future medical treatment and increase efficiency. During recording of information for specifying the used measuring device 24a and a treatment location, the serial number of the measuring device 24a and environment information (a captured image, a temperature, and a humidity around the treatment location) around the treatment location are recorded so as to periodically manage the accuracy of the measuring device 24a.

The example of FIG. 4 will be specifically described below. For example, it is assumed that the patient 23a to be treated is a cancer patient corresponding to the No. 8 patient B in FIG. 3 and requires administration of drugs such as an anticancer agent between 10 a.m. to 11 a.m. on this day. In this case, the patient B has the first photoreceiver 23 with a photoreceiver ID “P002” and the nurse A administers the drug to the patient B and performs treatment relating to the drug. The nurse A has the third photoreceiver 25 with a photoreceiver ID “N001”. Moreover, the body temperature and the blood pressure of the patient B need to be measured before the drug administration. For the measurement, a measuring device A having the second photoreceiver 24 with a photoreceiver ID “S001” is used. Drugs such as an anticancer agent for the patient B are carried by the cart A having the fourth photoreceiver 26 with a photoreceiver ID “C001”. In other words, the nurse A, the measuring device A, and the cart A need to be located near the patient B to be treated. In the present embodiment, the presence of the nurse A, the measuring device A, and the cart A is confirmed by checking if illumination IDs received by the photoreceivers attached to the nurse A, the measuring device A, and the cart A match an illumination ID received by the photoreceiver attached to the patient B. As shown in FIG. 3, if the illumination IDs received by the photoreceivers attached to the patient B, the nurse A, the measuring device A, and the cart A are all “12”, the patient B, the nurse A, the measuring device A, and the cart A with the photoreceivers are located in the illumination area of the same first luminaire 22 while the nurse A, the measuring device A, and the cart A are located near the patient B. If a match is confirmed based on a decision by the comparison unit 33, the processing unit 30 transmits a treatment permission signal through the communication network 50 and the communication device 27 to at least one of the photoreceivers located near the bed A in the hospital room 21, for example, the photoreceivers attached to the patient B, the nurse A, the measuring device A, and the cart A. This allows the light emitting parts and the sound generators on the photoreceivers in the hospital room 21 to notify the nurse A of permission for treatment. At this point, the recording unit 34 automatically records treatment information including the contents of treatment performed on the patient B, for example, “an anticancer agent was administered and then a blood pressure was measured”, a measurement result of “blood pressure”, a person in charge of treatment “nurse A”, a patient to be treated “patient B”, a treatment time “ten o'clock”, and a location “bed A”.

In this case, if the nurse A stays away from the patient B in the hospital at a predetermined treatment time, the third photoreceiver 25 attached to the nurse A receives an illumination ID (e.g., an illumination ID “23”) different from the illumination ID superimposed on the visible light 22a illuminating the bed of the patient B. In this case, the management unit 31 displays the illumination ID “23” corresponding to the nurse A in the list of FIG. 3. Subsequently, the comparison unit 33 of the processing unit 30 recognizes that only the nurse A is absent among the requirements for predetermined treatment on the patient B, issuing a warning on unprepared treatment. This warning is issued by, for example, transmitting information on the absence of the nurse A near the patient B to a nurse station from the processing unit 30. This warning allows the nurse station to instruct the nurse A to go to the patient B. In this case, this warning may be also issued by, for example, transmitting information on an instruction to go to the patient B, from the processing unit 30 to a portable terminal such as a PHS phone carried by the nurse A. The warning state is reset when the nurse A goes to the patient B and the third photoreceiver 25 attached to the nurse A starts receiving the visible light 22a with the same illumination ID “12” as the patient B. The resetting of the warning state allows confirmation of the preparation of treatment on the patient B.

The processing unit 30 may further include a transport management unit that prevents a person other than a person in charge of treatment from freely carrying the measuring device 24a or the cart 26a after treatment on the patient. After the treatment, the transport management unit confirms whether or not the photoreceiver attached to the measuring device 24a or the cart 26a and the photoreceiver attached to the person in charge of treatment are associated with each other by the association unit 32 as photoreceivers located in the illumination area of the same first luminaire 22. Thus, the provision of the transport management unit can authenticate a movement of a device after treatment, thereby preventing a person other than a person in charge of treatment from freely carrying the measuring device 24a or the cart 26a. In a method of preventing the carrying of the measuring device 24a or the cart 26a, when the photoreceiver attached to the measuring device 24a or the cart 26a is not associated with the photoreceiver attached to a person in charge of treatment, a signal for generating light or an alarm is transmitted to the photoreceiver attached to the person in charge of treatment, issuing a warning to the person in charge of treatment.

The illumination ID assigned to the first luminaire 22 varies among rooms in an office or a nurse station, among beds in a large hospital room, and among sections in a corridor. In other words, the illumination ID varies among the first areas to be distinguished from one another. In the present embodiment, the illumination IDs are set for the respective positions (first areas) and thus the positions can be specified based on the illumination IDs. Thus, the positions of the photoreceivers can be specified in real time in rooms in a nurse station or an office, on beds in a hospital room, and at points on a route in a corridor.

As shown in FIGS. 1A and 1B, the first luminaire 22 is mounted on the ceiling in the hospital room 21 and is assigned with different illumination IDs for multiple beds. The different illumination IDs assigned for the respective beds make it possible to identify a patient on or near a bed, a staff member (e.g., a nurse and a doctor) near a bed, and a device near a bed.

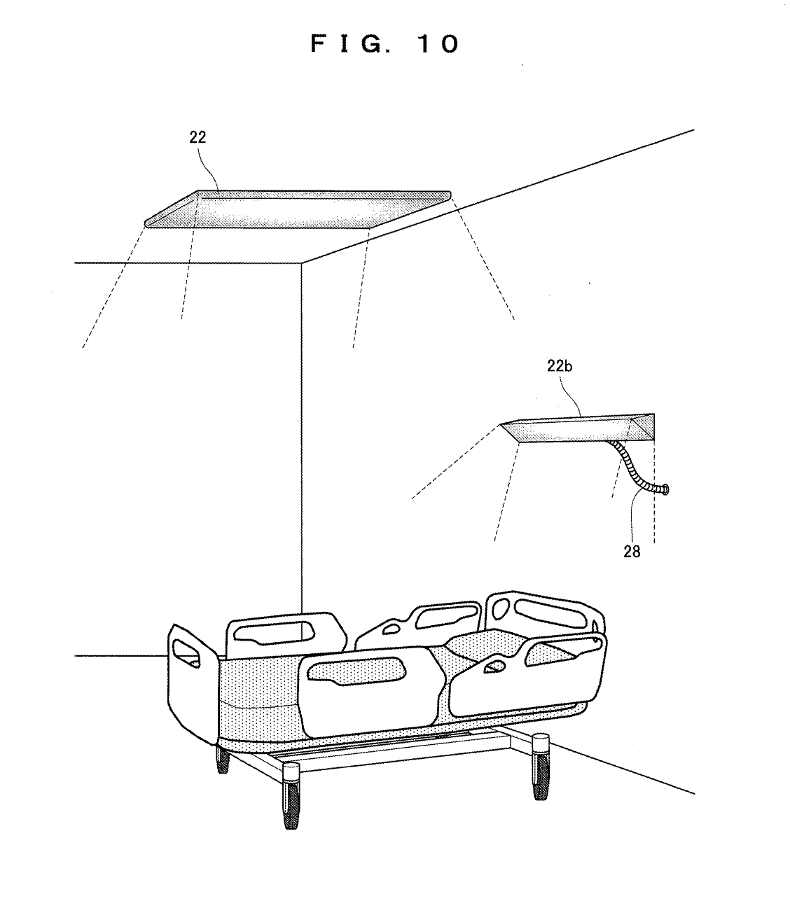

A patient or a nurse in various postures, e.g., crouching beside a bed in the hospital room 21 during treatment may interrupt the visible light 22a from the first luminaire 22. Thus, the visible light 22a may not be received by the photoreceivers. As shown in FIGS. 1A, 1B, and 10, in the present embodiment, second luminaires 22b are provided as auxiliary light sources (sub light sources) that laterally emit the visible light 22a, in addition to the first luminaire 22 serving as a main light source that is mounted on the ceiling and emits the visible light 22a from above. Thus, the photoreceivers can continuously and reliably receive the illumination IDs. FIG. 10 is an explanatory drawing of the positional relationship between the main light source (the first luminaire 22) and the auxiliary light source (the second luminaire 22b) according to the embodiment of the present invention. The second luminaire 22b emits the visible light 22a including information such as the same illumination ID as the first luminaire 22. If the visible light 22a from the first luminaire 22 is interrupted by a patient or a nurse, the blind spot of the visible light 22a from the first luminaire 22 is illuminated by the second luminaire 22b. In other words, the second luminaire 22b covers the blind spot of the first luminaire 22. For example, in a hospital room, the first luminaire 22 is mounted on the ceiling while the second luminaire 22b is mounted on a wall surface of the hospital room 21. In other words, the second luminaire 22b is mounted at a lower position than the first luminaire 22. Specifically, as shown in FIGS. 1A and 1B, the second luminaires 22b are preferably mounted on a wall surface near the head side of a bed so as to be located on the opposite sides of the bed as high as the lower back of the nurse 25a (e.g., at about 1 m from the floor surface), emitting horizontal visible light from the wall surface. Furthermore, the second luminaire 22b may be mounted at an adjustable mounting position or mounting angle on a wall surface or a bed with, for example, a flexible tool 28 having a variable shape or length. The second luminaire 22b modulates illuminance in synchronization with the illuminance modulation of the first luminaire 22. Thus, the same illumination ID as that assigned to the first luminaire 22 is superimposed on the visible light 22a concurrently with superimposition by the first luminaire 22. As shown in FIGS. 1A and 1B, for example, the first luminaire 22 and the second luminaire 22b may be synchronized with each other by connecting the first luminaire 22 and the second luminaire 22b via wires. The use of the auxiliary light source can more reliably authenticate the presence of the patient 23a and a person in charge of treatment, e.g., the nurse 25a near the bed of the patient 23a during treatment on the patient 23a.

The second luminaire 22b mounted near a bed assigned to the patient 23a does not always need to light. For example, the second luminaire 22b may light in response to a command from the processing unit 30 only when a subject (the patient 23a) and a person in charge of treatment (the nurse 25a) are located in the illumination area of the first luminaire 22 that emits the visible light 22a to the bed of the subject. For example, as shown in FIG. 1, the command from the processing unit 30 may be issued by means of connection between the processing unit 30 and the first luminaire 22 through the communication network 50 and connection between the first luminaire 22 and the second luminaire 22b via wires.

The illumination IDs may be classified into groups for predetermined areas such as the hospital room 21, a corridor, and a treatment room.

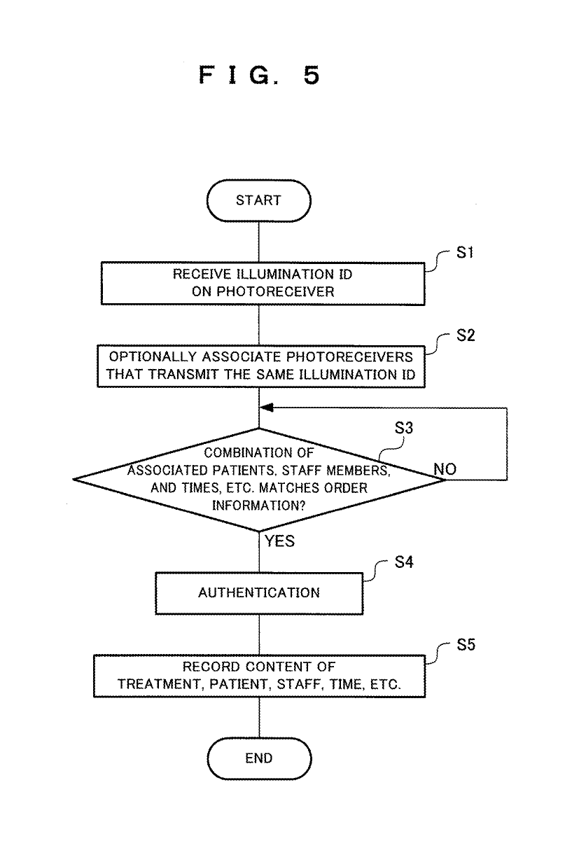

Subsequently, the specific operations of the authentication system 20 will be described below on a time-series basis. FIG. 5 is a flowchart showing an example of processing performed by the authentication system 20. As shown in FIG. 5, when the photoreceivers 23 to 26 receive the visible light 22a from the first luminaire 22 and receive illumination IDs (step S1), the photoreceivers 23 to 26 transmit the received illumination IDs to the processing unit 30. With reference to the received illumination IDs, the processing unit 30 optionally associates the photoreceivers having received the same illumination ID (step S2). Then, it is decided whether or not a combination of the associated photoreceivers matches the contents of a treatment order (step S3). If there is a match (YES in step S3), the processing unit 30 authenticates the completion of preparation for predetermined treatment and then provides a notification about the authentication (step S4). Furthermore, the processing unit 30 monitors whether the authentication is continued or not, and then records medical information about the patient 23a, a person in charge of treatment, e.g., the nurse 25a, a treatment time, a treatment location, and the contents of treatment if necessary (step S5).

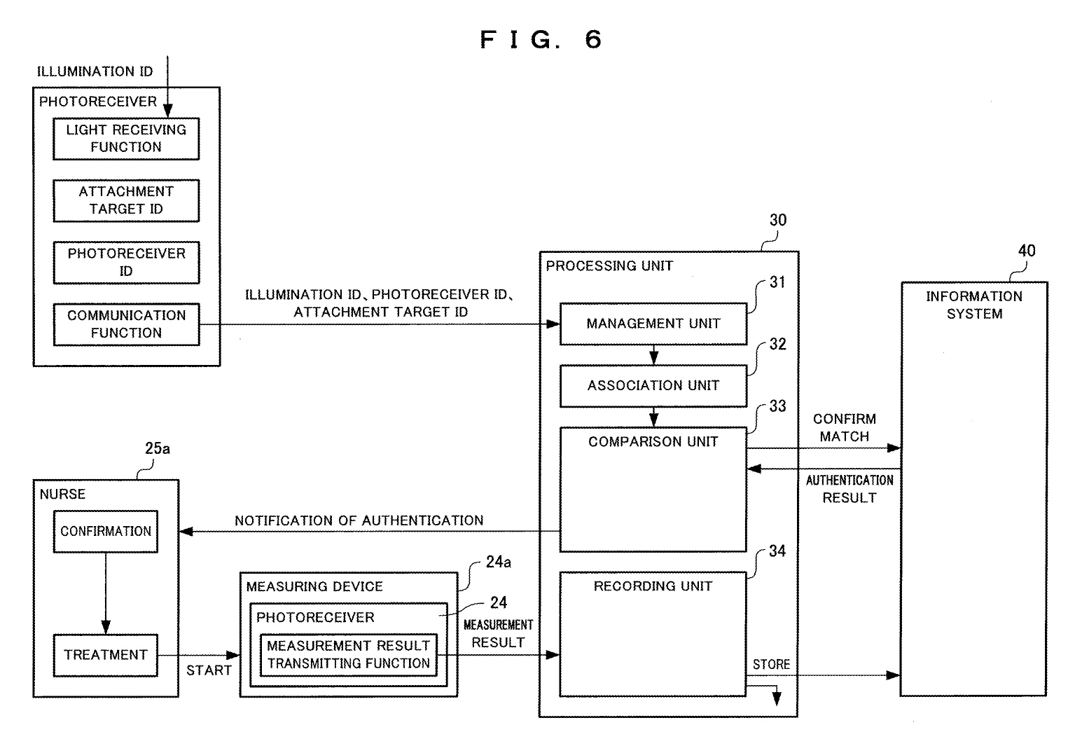

FIG. 6 is a block diagram showing an example of information transmission by the authentication system 20. In FIG. 6, a person in charge of treatment is the nurse 25a and the photoreceiver transmits a photoreceiver ID and a target ID with an illumination ID to the processing unit 30.

As shown in FIG. 6, the photoreceivers having received the illumination IDs transmit the received illumination IDs with the prestored photoreceiver IDs and target IDs to the processing unit 30 through the communication network 50. The processing unit 30 obtains and manages the illumination IDs received by the photoreceivers, by means of the management unit 31. Information on the illumination IDs received by the photoreceivers is delivered to the association unit 32. The association unit 32 associates the photoreceivers that receive the same illumination ID. When the target IDs of the associated photoreceivers include a subject, that is, a patient, the comparison unit 33 confirms whether there is a match between combinations of the photoreceiver IDs and the target IDs that are included in information on treatment orders for the patient and combinations of the photoreceiver IDs and the target IDs currently associated by the association unit 32. If the comparison unit 33 confirms that there is a match, the combinations of the photoreceiver IDs and the target IDs currently associated by the association unit 32 are transmitted to the information system 40. The information system 40 confirms whether there is a match between the transmitted combinations of the photoreceiver IDs and the target IDs and the information on treatment orders, and then transmits the confirmation result to the processing unit 30. When the information system 40 confirms that there is a match, the processing unit 30 notifies the nurse 25a of authentication on the completion of preparation necessary for medical treatment. In response to the notification, the nurse 25a starts the treatment. In this way, the processing unit 30 and the information system 40 perform dual authentication, more reliably preventing medical accidents. The authentication by the information system 40 may be omitted. If authentication performed by the information system 40 is omitted, when the comparison unit 33 confirms that there is a match, the processing unit 30 notifies the nurse 25a of authentication on the completion of preparation necessary for medical treatment. The processing unit 30 automatically records subjects (patients), persons in charge of treatment (e.g., nurses), the contents of treatment, and treatment locations by means of the recording unit 34 while the processing unit 30 continuously performs authentication. If the photoreceiver has a clock function and a communication function, the start time and the termination time of treatment are desirably recorded by the recording unit 34. The information recorded by the recording unit 34 is transmitted to the information system 40 and then is stored in the information system 40. If treatment includes an examination using the measuring device 24a, the examination result is transmitted to the processing unit 30 from the second photoreceiver 24 attached to the measuring device 24a, and then the transmitted examination result is also automatically recorded in the recording unit 34. FIG. 6 illustrates the second photoreceiver 24 that has the function of transmitting measurement results. The second photoreceiver 24 receives detection results from the measuring device 24a and then transmits the results to the processing unit 30.

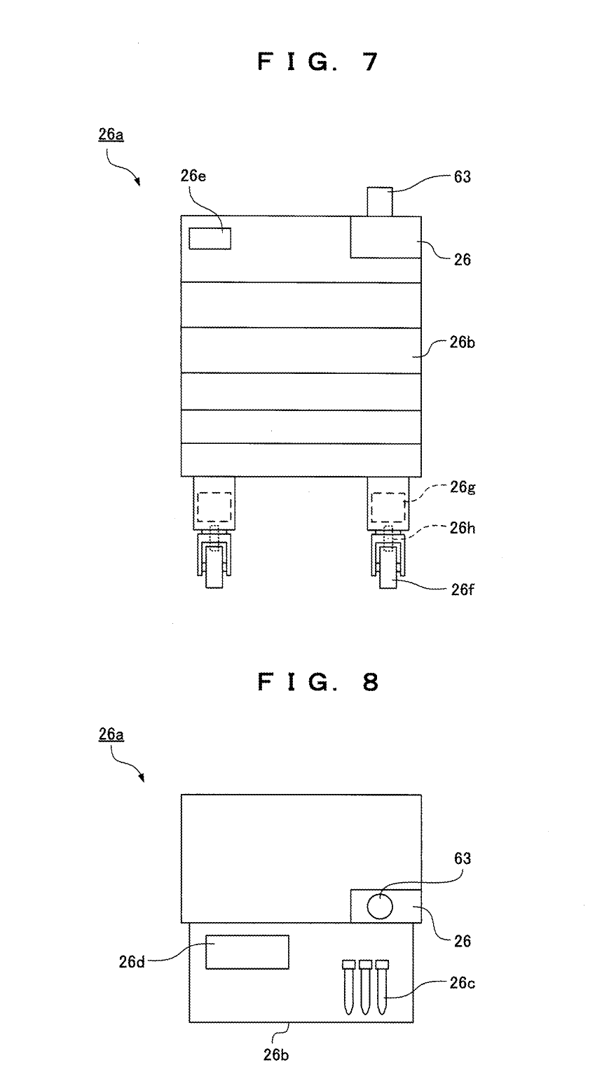

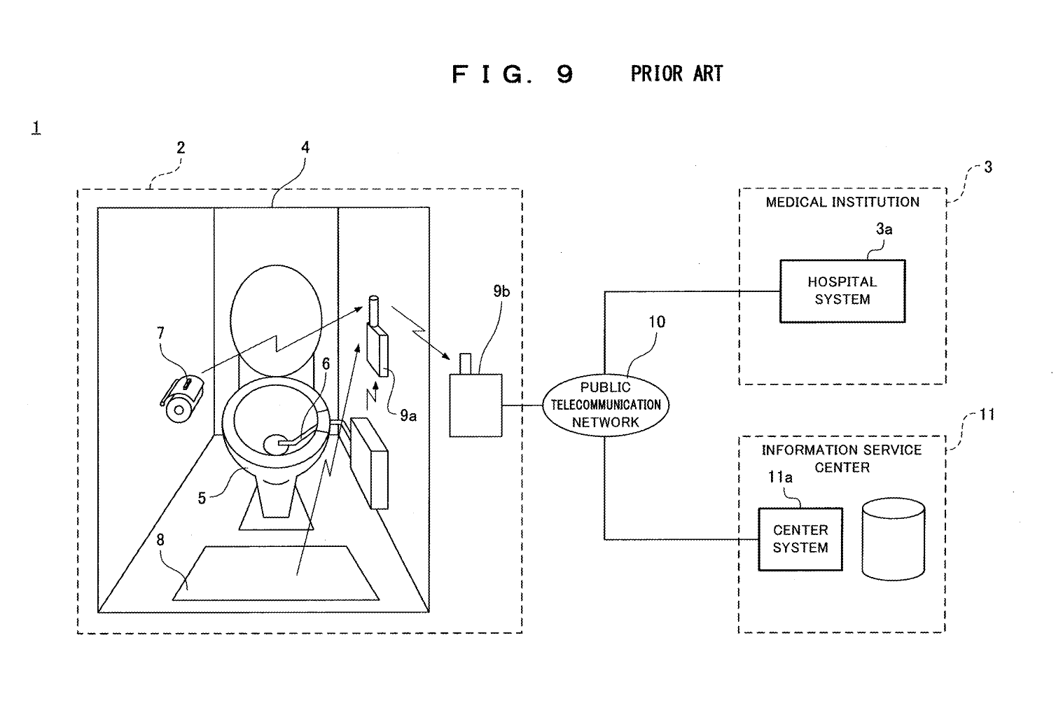

FIG. 7 is a front view showing an example of the cart 26a used in the authentication system 20. FIG. 8 is a plan view of the cart 26a illustrated in FIG. 7. FIG. 8 shows an opened drawer 26b. As shown in FIG. 7, the cart 26a includes multiple lockable drawers 26b for storing drugs. As shown in FIG. 8, the drawers 26b can be used for carrying drugs 26c and a device 26d that are used for treatment on the patient 23a. The cart 26a includes drive units 26g for driving of driving wheels 26f and brakes 26h.

If the cart 26a is necessary for treatment on the patient 23a, the fourth photoreceiver 26 is selected as one of the conditions of permission for the treatment. If the drug 26c, e.g., an anticancer agent to be strictly managed is administered to the patient 23a, the drug 26c is not carried by a person in charge of treatment, e.g., the nurse 25a but is stored in the drawer 26b of the cart 26a as shown in FIGS. 7 and 8, preferably managing authentication on the carrying of the drug 26c and a transport route by the authentication system 20. Moreover, a transport permission/authentication condition may be a match between the illumination ID received by the photoreceiver attached to a person in charge of treatment, e.g., the nurse 25a and the illumination ID received by the photoreceiver attached to the cart 26a when the cart 26a starts carrying the drug 26c. For example, if the illumination ID received by the photoreceiver attached to a person in charge of treatment, e.g., the nurse 25a does not match the illumination ID received by the photoreceiver attached to the cart 26a, the processing unit 30 may transmit warning information to a nurse station when it is confirmed that the illumination ID received by the fourth photoreceiver 26 has been changed in response to a movement of the cart 26a.

When the processing unit 30 notifies the fourth photoreceiver 26 of permission for treatment, the cart 26a may unlock the drawers 26b that store the drugs 26c used for the treatment. With this configuration, the drugs 26c to be administered are confirmed for each of the patients 23a and thus the drugs 26c can be precisely and efficiently administered to the patients 23a.

The cart 26a may include a display unit 26e that displays information on treatment orders and information in the cart.

What is claimed is:

1. An authentication system authenticating treatment based on a treatment order in a facility, the system comprising:
a light source that emits illumination light including an illumination ID for specifying a location in the facility as information;
a plurality of photoreceivers that transmit the illumination ID based on the illumination light and a prestored target ID when receiving the illumination light from the light source as data; and
a processing unit that associates the photoreceivers located in an illumination area of the same light source based on the data transmitted from the photoreceivers, and then authenticates treatment by deciding whether a combination of the associated photoreceivers matches a combination of the photoreceivers based on the treatment order.

2. The authentication system in a facility according to claim 1, wherein the treatment order is an order of treatment performed on a subject in a predetermined time period, and
the combination of the photoreceivers at least includes the photoreceiver attached to the subject and the photoreceiver attached to a person in charge of treatment on the subject.

3. The authentication system in a facility according to claim 2, wherein the light source includes a main light source and a sub light source that emit illumination light including the same illumination ID as information.

4. The authentication system in a facility according to claim 3, wherein the sub light source is mounted at a lower position than the main light source.

5. The authentication system in a facility according to claim 4, wherein the main light source is mounted on a ceiling, and
the sub light source is mounted around the subject.

6. The authentication system in a facility according to claim 1, wherein the illumination light is visible light.

7. The authentication system in a facility according to claim 1, wherein the light source is an LED lamp.

8. The authentication system in a facility according to claim 3, wherein the sub light source horizontally emits the illumination light to the subject.

9. The authentication system in a facility according to claim 3, wherein the sub light source is mounted at a height of 1 m from a floor surface of the facility.

10. The authentication system in a facility according to claim 3, wherein the light source superimposes the illumination ID on the illumination light by modulating an illuminance of the emitted illumination light, and
the sub light source modulates an illuminance in synchronization with illuminance modulation by the main light source.

11. The authentication system in a facility according to claim 3, wherein the sub light source lights up when the photoreceiver attached to the subject and the photoreceiver attached to the person in charge of treatment are located in the illumination area of the main light source.

12. The authentication system in a facility according to claim 2, wherein after the treatment is authenticated, the processing unit authenticates a movement of a device for treatment on the subject by deciding whether or not the photoreceiver attached to the person in charge of treatment on the subject and the photoreceiver attached to the device for treatment on the subject are located in the illumination area of the same light source.

13. The authentication system in a facility according to claim 2, wherein the processing unit further includes a recording unit that records information for specifying information on a treatment time, information on a location of treatment, information for specifying the person in charge of treatment, and information for specifying the treated subject.

14. The authentication system in a facility according to claim 1, wherein if the treatment is authenticated, the processing unit notifies at least one of the photoreceivers of the authentication.
